(19) United States
(12) Patent Application Publication
(10) Pub. No.: US 2009/0132400 A1
(43) Pub. Date: May 21, 2009

(54) DATA METERING

(75) Inventor: Adrian E. Conway, Weston, MA (US)

Correspondence Address: VERIZON;PATENT MANAGEMENT GROUP, 1320 North Court House Road, 9th Floor, ARLINGTON, VA, 22201-2909, US

(73) Assignee: Verizon Services Organization Inc., Irving, TX (US)

(21) Appl. No.: 11/863,835

(22) Filed: Sep. 28, 2007

(51) Int. Cl. G06Q 30/00; G06Q 50/00

(52) U.S. Cl. 705/34

(57) ABSTRACT

A charging factor is determined applicable to each time interval in a period of time during which at least one data transfer was conducted. An amount of data transferred during each time interval is determined. A total charge applicable to the at least one data transfer is computed based at least in part on the charging factor applicable to each time interval and the amount of data transferred. Alternatively or additionally, a plurality of potential start times and an amount of data for a data transfer are identified. A set of time intervals associated with each of the potential start times are determined. For each of the potential start times, an estimated charge applicable to the data transfer is computed based at least in part on a charging factor applicable to each of one or more time intervals associated with the potential start time and the amount of data estimated to be transferred.

### BACKGROUND INFORMATION

Data providers such as Internet service providers (ISPs) and the like often charge a fixed fee for data services. For example, an ISP may charge a customer a fixed monthly fee for providing the customer with Internet service. The fixed monthly fee may allow the customer to transfer, e.g., upload and/or download, an unlimited amount of data. In some cases, a fixed fee may be combined with a fee based on usage. For example, a customer may pay a fixed monthly fee in addition to a variable fee charged for data transferred in excess of a predetermined number of bytes. Further, in some cases, a customer may be charged only a variable fee based on an amount of data transferred.

Present variable fees may be implemented with the goal of generating additional revenue for a service provider. However, present variable fees may actually have the effect of limiting a service provider's revenue by influencing a customer to limit the customer's data traffic so as not to exceed a predetermined number of bytes within a predetermined period of time. Further, present variable fees do not take into account varying network loads at different times of day, times of week, etc.

### BRIEF DESCRIPTION OF THE DRAWING FIGURES

FIG. 1 illustrates an exemplary system for metering data traffic.

FIG. 2 illustrates an exemplary process for determining a fee to be charged for one or more transfers of data in a time period.

FIG. 3 illustrates an exemplary process for an application on a client device to schedule a transfer of data to optimize fees for the transfer of data.

### DETAILED DESCRIPTION OF THE PREFERRED EMBODIMENTS

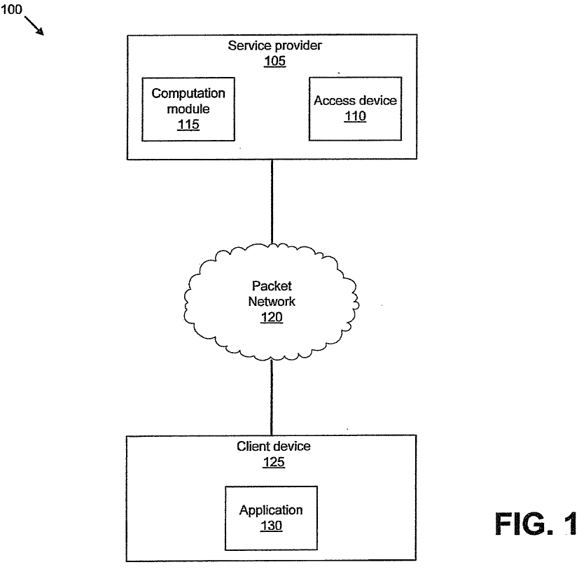

FIG. 1 illustrates an exemplary system 100 for metering data traffic. A service provider 105 includes at least one access device 110 and a computation module 115. The service provider 105 provides data, generally through a packet network 120, to a client device 125. A software application 130 is generally included on the client device 125 for performing various operations, including receiving, and managing the receipt of, data from packet network 120.

Service provider 105 may be any one of a variety of entities capable of providing data to client device 125. For example, service provider 105 may be an Internet service provider (ISP) or the like. Further, although not explicitly illustrated in FIG. 1, service provider 105 may include virtually any server or other entity that provides data to client device 125, e.g., via network 120. For example, service provider 105 may include a video on demand (VOD) server or other content server that provides a media stream, e.g., MPEG, MP3, etc., to client device 125.

Access device 110 may be any one of a variety of devices that connect service provider 105 to packet network 120. For example, access device 110 may be a router, an access multiplexer, etc. Alternatively, access device 110 may be a modem or the like that connects service provider 105 directly to client device 125 and not via packet network 120. Although one access device 110 is shown in FIG. 1 for ease of illustration, note that service provider 105 may and likely will include multiple access devices 110.

Computation module 115 is generally tangibly embodied as a set of computer-executable instructions tangibly embodied on a computer readable medium in one or more computing devices, e.g., servers, within service provider 105. It is even possible for computation module 115 to be included within access device 110. The instructions included within computation module 115 include instructions for metering data provided to client device 125, and for determining fees to be charged for such data.

For example, computation module 115 may perform a calculation to determine an amount to be charged for data sent to and/or from client device 125 during a length of time T that is broken up into K intervals. The time period T may be a day, a number of days, a week, a calendar month, etc. Each of the K intervals may be a period of hours, days, etc. The time T may be broken into time intervals (Δₖ₋₁, Δₖ), where k=1, 2, . . . , K. Each time interval (Δₖ₋₁, Δₖ) may be of an equal duration T/K, although the time intervals (Δₖ₋₁, Δₖ) need not all be all of equal length. A total number of bytes Bₖ is transferred from service provider 105 to client device 125 and/or vice versa during a time interval (Δₖ₋₁, Δₖ). A base fixed fee F is defined as a base fee, e.g., in a currency such as dollars, that service provider 105 charges to a user of client device 125 for transfer of data during the time T. An excess fee E is a charge, e.g., in a currency such as dollars, per byte of data measured to have been transferred during the period T in excess of N bytes. A function M=m(k), m(k)>0, sometimes referred to as a “charging function,” is defined so as to provide a multiplying charging factor to be applied for each time interval (Δₖ₋₁, Δₖ). Then the total amount C(T) charged to a user of the client device 125 for a period of time [0, T] is:

$$C ( T ) = F + E * Max \{ 0 , ⌊ {\sum }_{k = 1}^{k = K} m ( k ) {B}_{k} ⌋ - N \} . \qquad Equation ( 1 )$$

The charging function M generally includes a set of charging factors m(k)={m(1), m(2), . . . , m(K)}, where each m(k) may be set according to various considerations. In two special cases, it is possible that each m(k)=0, or that each m(k)=(1). If each m(k)=0, then C(T)=F, that is, a user is simply charged a fixed fee for transferring data to and/or from client device 125. If each m(k)=1, then the charge C(T) is simply a fixed fee for time period T plus a charge of E for each byte of data transferred during the time [0, T] in excess of the amount N.

However, more commonly, m(k) may be set for a particular time interval (Δₖ₋₁, Δₖ) according to a general volume of data traffic on network 120 for the time interval (Δₖ₋₁, Δₖ). That is, if the time interval (Δₖ₋₁, Δₖ) represents a period of one or more hours in the middle of the night, m(k) may be set to a lower number than m(k) for a time interval (Δₖ₋₁, Δₖ) representing a period of one or more hours in the middle of the day. To take just one example, during time intervals (Δₖ₋₁, Δₖ) for which data traffic is expected to be moderate or “normal,” m(k) may be set to be 1.0, whereas for time intervals (Δₖ₋₁, Δₖ) associated with lower or “light” amounts of traffic, m(k) may be set to be 0.5, and for time intervals associated with higher or “heavy” amounts of traffic, m(k) may be set to be 2.0. Further, m(k) could be set to zero for a first set of time intervals (Δₖ₋₁, Δₖ) and set to values greater than zero for a second set of time intervals (Δₖ₋₁, Δₖ). Setting m(k) to zero for the first set of time intervals would effectively allow a customer to transfer an unlimited amount of data during the first set of time intervals (Δₖ₋₁, Δₖ) while incurring only the base fee F. However, for an amount of data transferred during the second set of time intervals (Δₖ₋₁, Δₖ) above the threshold N, the customer will in effect pay a surcharge over and above the base fee F.

It is also possible that F and N are set to a value of zero and effectively omitted from Equation (1). That is, it is possible that no base fee is charged for a time period T, meaning that C(T) is based solely on applicable fees for a number of bytes Bₖ. Alternatively, N but not F may be set to zero, meaning that some portion of the total charge C(T) is based on a per-byte charge for every byte of data that is transferred.

Advantageously, various variables affecting a total charge C(T) may be modified by service provider 105 for various purposes, e.g., maximizing revenues, rewarding loyal customers, providing customers with incentives to use network 120, creating a more even distribution of traffic on network 120, etc. For example, some or all of the charging function M, the threshold value N, and values for F and E may be modified in response to changing traffic conditions on network 120, observed historical trends relating to usage of network 120, changes in a number of client devices 125 being served through network 120, or simply a desire to alter pricing for usage of network 120, etc.

Further, some or all of the charging function M, the threshold value N, and values for F and E may be varied according to other factors. For example, service provider 105 may wish to impose different charges for uploads and downloads, i.e., for data transfers to client device 125 as opposed to data transfers from client device 125. Thus, a first charging function M and/or a first set of values N, F, and/or E may be applied to data transferred in a first direction, e.g., uploaded to client device 125, and a second charging function M and/or a second set of values N, F, and/or E may be applied to data transferred in a second direction, e.g., downloaded from client device 125. Similarly, different charging functions M could be applied to usage of different portions of network 120, e.g., portions of network 120 owned and/or controlled by service provider 105, as opposed to portions of network 120 owned and/or controlled by some other party. For example, a first portions of network 120 may be designated for “in network” charges, while a second portions of network 120 may be designated for “out of network” charges. It will be understood that first and second portions of network 120 as discussed above may sometimes simply be referred to as first and second networks.

Moreover, the charge Bₖ is not necessarily a charge per byte transferred. For example, service provider 105 may provide services other than through a packet network 120, e.g., a cellular phone service where data traffic is generally measured not according to units of data, e.g., bytes, but according to units of connection time, e.g., minutes-of-use (MOU), etc., or according to some unit of data other than bytes, e.g., bits, etc. Accordingly, in Equation (1), the charge Bₖ may be a charge per MOU, per bits, etc., in excess of a number threshold number N of MOUs, bits, etc.

Continuing with FIG. 1, packet network 120 is a packet switched communication network e.g., an Internet Protocol (IP) network that is a wide-area network (WAN) such as the Internet. Packet network 120 generally interconnects various computing devices and the like, such as servers within service provider 105, client device 125, etc. Interconnections in network 120 may be made by various media including wires, radio frequency transmissions, optical cables, etc. Packet network 120 generally maintains a common addressing scheme such that each connected device is uniquely addressable by a network address. Routing devices generally interconnect local area networks (LANs), not shown in FIG. 1, that may include devices such as client device 125. Other devices connecting to packet network 105, e.g. switches, intervening routers, etc., are omitted for simplicity of illustration in FIG. 1.

Client device 125 may be any one of a number of computing devices, such as a personal computer, handheld computing device, cellular telephone, set-top box, etc. Although only one client device 125 is shown in FIG. 1 for ease of illustration, system 100 generally includes multiple, indeed many, client devices 125.

Client device 125 generally includes software application 130 tangibly embodied as a set of computer-executable instructions on a computer readable medium within client device 125. Software application 130 may include a user interface such as a graphical user interface (GUI) through which a user may obtain information concerning fees that may be or that are charged for transferring data to and/or from service provider 105. For example, upon selecting a file for download a user may be presented with an estimate of a cost of the download based on a calculation performed according to Equation (1). The GUI may further allow the user to select whether to proceed with the download after viewing the estimated cost. Further, software application 130 may include a mechanism, e.g., a menu, a form, or the like, whereby a user may schedule a transfer of data at a time or times to allow the user to control and in many cases reduce or minimize the amount of fees charged for the transfer of data.

For example, software application 130 may be configured to display the charging function M, and/or values of E, F, and N to a user of client device 125. Accordingly, a user may choose to execute or schedule data transfers during one or more time intervals (Δₖ₋₁, Δₖ) associated with lower values for m(k), thereby minimizing the total charge C(T) for the data transfer.

Additionally or alternatively, software application 130 and/or other applications within client device 125 may be configured to schedule data transfers according to Equation (1) to minimize the total charge C(T) for the data transfer. In addition, application 130 may vary a data transfer rate, e.g., a transfer control protocol (TCP) transfer rate, according to the value of m(k) associated with a time interval (Δₖ₋₁, Δₖ). That is, application 130 may employ higher data transfer rates for time intervals (Δₖ₋₁, Δₖ) associated with lower values of m(k), and lower data transfer rates for time intervals (Δₖ₋₁, Δₖ) associated with higher values of m(k).

Thus, in many cases, it is possible for application 130 to optimize data transfers to minimize the total charge C(T) for the data transfer. For example, service provider 105 or some other source may make, and may make available, an estimate of an expected average TCP bit rate for a time interval (Δₖ₋₁, Δₖ). One instance where such an estimate could be provided is where service provider 105 is providing video on demand services. Where a total amount of data to be transferred, e.g., a file size, is known, then Equation (1) may be used to compute an expected charge C(T) given an expected start time for the transfer. Given a range of potential start times, application 130, or, alternatively, service provider 105, could determine a start time expected to incur the lowest expected charge C(T). A data transfer could then be initiated at such start time, e.g., by application 130, or, alternatively, service provider 105.

Another possible way in which application 130 and/or a user of client device 125 may make use of Equation (1) is to establish a budget or maximum charge C(T) permitted to be incurred. Data transfers may then be scheduled according to Equation (1) using average historical data transfer rates for given time intervals (Δₖ₋₁, Δₖ) to compute expected costs for the time intervals (Δₖ₋₁, Δₖ). Based on such computation, application 130, or a user of application 130, may select a start time for a data transfer so as to obtain the data transfer as soon as possible and/or at the most rapid rate possible within the established budget.

In general, computing devices such as client device 125, servers within service provider 105, etc. may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices generally each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Data stores may be associated with various computing devices and may include a relational database management system (RDBMS). An RDBMS generally employs Structured Query Language (SQL) in addition to a language for creating, storing, editing, and executing stored procedures, such as the PL/SQL language mentioned above. However, it is to be understood that data stores associated with a computing device may be some other kind of database such as a hierarchical database, a set of files, an application database in a proprietary format, etc. A data store often includes a computing device employing a computer operating system such as one of those mentioned above, and are accessed via a network in any one or more of a variety of manners, as is well known.

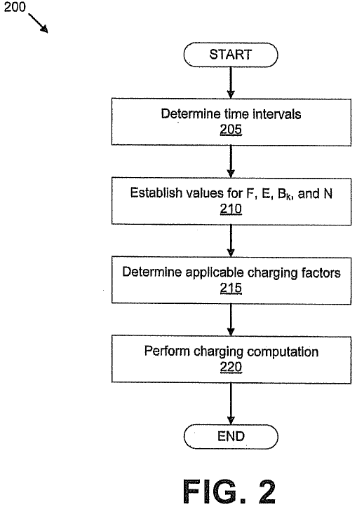

FIG. 2 illustrates an exemplary process 200 for determining a fee to be charged for one or more transfers of data in a time period T. Process 200 may be executed according one or more sets of computer-executable instructions, e.g., instructions included in computation module 115 and/or application 130.

Process 200 begins in a step 205, in which one or more time intervals in which data was transferred in the time period T are determined. For example, as discussed above, a time period T may include a calendar month, week, etc., and time intervals within the time period T may include specified hours, days, etc. A common instance is for the time period T to include a calendar month or similar billing period of service provider 105, and for time intervals within the time period T to include specified intervals of one or more hours within each calendar day. As mentioned above, the number of time intervals identified may be denoted as K time intervals.

Next, in step 210, values are established for variables applicable to data transfers in time period T. For example, as discussed above, a fixed base fee F is generally applicable to a billing period of service provider 105, e.g., to a time period T. Further, a threshold amount of data N and an excess fee E representing a charge per amount of data over the threshold N may also be established. Further, an amount of data Bₖ transferred during each time interval determined in step 205 is also generally determined in step 210.

Next, in step 215, a charging factor m(k) is determined or identified for each of the K time intervals identified as discussed above with respect to step 205. Charging factors m(k) determined according to a charging function M are discussed above.

Next, in step 220, a total charge is determined for the one or more data transfers in the time period T. For example, a total charge C(T) may be determined as described above with respect to Equation (1).

Following step 220, process 200 ends.

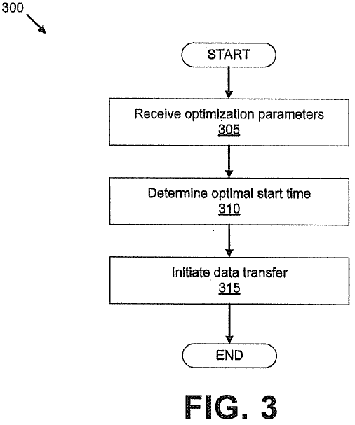

FIG. 3 illustrates an exemplary process 300 for an application 130 on a client device 125 to schedule a transfer of data to optimize fees for the transfer of data.

Process 300 begins in a step 305, in which application 130 receives parameters for optimizing a scheduling or an initiation of a transfer of data. Such parameters generally include a set of potential start times for the transfer of data, or alternatively a set of times by which the transfer of data must be complete. Further, such parameters generally include values such as those discussed above such as a fixed base fee F for a time period T in which the data transfer is to occur, a threshold amount of data N, and an excess fee E representing a charge per amount of data over the threshold N that is transferred during the time period T. Another parameter that may be supplied in step 305 is an estimated amount of data to be transferred, e.g., a file size or an amount of data to be streamed. Other parameters are possible, such as a maximum budgeted fee amount for the data transfer, minimum tolerated transfer rates, estimated data transfer rates during particular time intervals, etc., as discussed above.

Application 130 may in step 305 receive some or all of the foregoing parameters via network 120, e.g., values such as F, N, and E may be provided by service provider 105. Additionally and/or alternatively, some or all of the parameters received in step 305, such as the set of potential start times, a maximum budgeted fee amount for the data transfer, etc. may be received via input to a user interface, e.g., a GUI, provided according to instructions included in application 130.

Next, in step 310, application 130 determines an optimal start time for the data transfer, generally based on the parameters received in step 305. For example, for each of the potential start times identified in step 305, application 130 may use Equation (1) or the like to determine a total estimated cost for the data transfer according to each of the potential start times. As noted above, values for F, N, and E, variables used in Equation (1) as described above, may be supplied to application 130 is parameters in step 305. Further, based on the estimated amount of data to be transferred, application 130 may determine one or more time intervals in which the data transfer is expected to occur, and application 130 may thereby determine a charging factor or factors m(k) applicable to each such time interval. Having determined a total estimated cost for the data transfer according to each of the potential start times, application 130 may then select an actual start time from the set of potential start times to minimize the total cost of the data transfer.

Alternatively, as discussed above, a parameter provided to application 130 may include a maximum budgeted amount for the data transfer. In this case, application 130 may that has associated there with a total cost at or below the maximum budgeted amount. Further, application 130 may take into account estimated transfer rates during particular time intervals and/or minimum tolerated transfer rates as discussed above to select an actual start time from the set of potential start times.

Further, as an alternative to application 130 selecting an actual start time from a set of potential start times according to instructions included within application 130, it is possible that a GUI included in application 130 may provide for display to a user a list of potential start times and costs associated with each of the start times, possibly along with an estimated time to complete the data transfer associated with each of the start times. A user may then select a desired actual start time for the data transfer based on the foregoing information.

Next, in step 315, application 130 initiates the data transfer according to the optimal start time selected in step 310. Alternatively, a user may view information concerning the potential start times in a GUI provided by application 130 as described above, and may manually initiate a data transfer after reviewing such information.

Following step 315, process 300 ends.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, it is to be understood that the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites explicitly to the contrary.

What is claimed is:

1. A method, comprising:
determining one or more time intervals in a period of time during which at least one data transfer was conducted;
determining a charging factor applicable to each time interval;
determining an amount of data transferred during each time interval; and
computing a total charge applicable to the at least one data transfer based at least in part on the charging factor applicable to each time interval and the amount of data transferred during each time interval.

2. The method of claim 1, further comprising:
determining a base fixed fee applicable for the period of time;
determining a threshold amount of data that may be transferred during the period of time before incurring a charge based on an amount of data transferred during the time period; and
computing the total charge applicable to the at least one data transfer based further at least in part on the base fixed fee and the threshold amount of data.

3. The method of claim 1, further comprising determining the charging factor applicable to a time interval based at least in part on at least one of whether the data transfer is an upload or a download, a portion of a network being used, a time of day associated with the time interval, and a traffic load associated with the time interval.

4. The method of claim 1, further comprising measuring the amount of data transferred according to at least one of bytes and minutes-of-use.

5. The method of claim 1, the one or more time intervals including a first time interval and a second time interval, the charging factor applicable to the first time interval being the charging factor applicable to the second time interval.

6. The method of claim 1, further comprising conducting the at least one data transfer.

7. The method of claim 1, the at least one data transfer being conducted over a packet switched network.

8. The method of claim 1, the at least one time interval being a plurality of time intervals, the method further comprising setting the charging factor applicable to at least one time interval in the plurality of time intervals to zero.

9. The method of claim 1, tangibly embodied as computer-executable instructions stored on a computer-readable medium.

10. A method, comprising:
determining an amount of data to be transferred in a data transfer;
identifying a plurality of potential start times for the data transfer;
determining a set of time intervals associated with each of the potential start times based at least in part on the amount of data; and
for each of the potential start times, computing an estimated charge applicable to the data transfer based at least in part on a charging factor applicable to each of one or more time intervals associated with the potential start time and the amount of data estimated to be transferred during each time interval.

11. The method of claim 10, further comprising selecting one of the potential start times based at least in part on the estimated charge computed for the one of the potential start times.

12. The method of claim 10, further comprising displaying the estimated charge for at least one of the start times in a user interface.

13. The method of claim 10, further comprising conducting the data transfer beginning at one of the potential start times.

14. The method of claim 10, further comprising providing a user interface for a user to provide input indicating a start time selected from the potential start times, whereby the data transfer is scheduled to be initiated at the start time selected from the potential start times.

15. The method of claim 10, further comprising:
determining a base fixed fee applicable for the period of time that includes each set of time intervals;
determining a threshold amount of data that may be transferred during the period of time before incurring a charge based on an amount of data transferred during the time period; and
computing the total charge applicable to the at least one data transfer based further at least in part on the base fixed fee and the threshold amount of data.

16. The method of claim 10, further comprising determining the charging factor applicable to a time interval based at least in part on at least one of whether the data transfer is an upload or a download, a portion of a network being used, a time of day associated with the time interval, and a traffic load associated with the time interval.

17. The method of claim 10, further comprising measuring the amount of data transferred according to at least one of bytes and minutes-of-use.

18. The method of claim 10, the one or more time intervals associated with one of the potential start times including a first time interval and a second time interval, the charging factor applicable to the first time interval being the charging factor applicable to the second time interval.

19. The method of claim 10, tangibly embodied as computer-executable instructions stored on a computer-readable medium.

20. A system comprising a server that includes a computation module configured to:
determine one or more time intervals in a period of time during which at least one data transfer was conducted;
determine a charging factor applicable to each time interval;
determine an amount of data transferred during each time interval; and
compute a total charge applicable to the at least one data transfer based at least in part on the charging factor applicable to each time interval and the amount of data transferred during each time interval.

21. A system comprising a client device that includes an application configured to:
determine an amount of data to be transferred in a data transfer;
identify a plurality of potential start times for the data transfer;
determine a set of time intervals associated with each of the potential start times based at least in part on the amount of data; and
for each of the potential start times, computing an estimated charge applicable to the data transfer based at least in part on a charging factor applicable to each of one or more time intervals associated with the potential start time and the amount of data estimated to be transferred during each time interval.

22. The system of claim 21, the application further configured to select one of the potential start times based at least in part on the estimated charge computed for the one of the potential start times.
